(19) United States
(12) Patent Application Publication
(10) Pub. No.: US 2003/0226506 A1
(43) Pub. Date: Dec. 11, 2003

(54) A METHOD OF AND A DEVICE FOR AUTOMATICALLY MILKING AN ANIMAL

(75) Inventor: Karel van den BERG, Bleskensgraaf (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, Zug (CH)

(21) Appl. No.: 10/249,958

(22) Filed: May 22, 2003

(30) Foreign Application Priority Data
Jun. 6, 2002 (NL) 1020783

(51) Int. Cl. A01J 3/00; A01J 5/00

(52) U.S. Cl. 119/14.02

(57) ABSTRACT

A method of automatically milking an animal having at least two udder quarters. The milking of the at least two udder quarters is performed at least partially simultaneously. The method includes the step of controlling the milking intensity during at least a part of the milking of each udder quarter in such a way that all udder quarters will be milked-out according to a predetermined chronological order. The method also includes the step of determining, during milking, for each udder quarter a value of a milking parameter of the milk obtained from the relevant udder quarter, the milking intensity during at least a part of the milking of each udder quarter being controlled with the aid of the determined value of the milking parameter in such a way that all udder quarters will be milked-out according to a predetermined chronological order.

### CROSS REFERENCE TO RELATED APPLICATIONS

This application claims priority from Dutch patent application no. 1020783 filed Jun. 6, 2002, the contents of which are hereby incorporated by reference in their entirety. This application also relates to U.S. patent application Ser. No. 10/249,955 by the present inventor entitled “A device for automatically milking an animal” filed concurrently herewith, the contents of which are hereby incorporated by reference in their entirety.

### BACKGROUND OF INVENTION

1. Field of the Invention

The invention relates to the field of milking and more particularly to methods of automatically milking animals. The invention further relates to devices for automatically milking an animal.

2. Description of the Related Art

Methods are known for automatically milking dairy animals. Such methods may involve the connection of at least two teat cups to respective udder quarters of the animal, wherein the milking of the udder quarters is performed at least partially simultaneously. Such methods may comprise the step of controlling the milking intensity during at least a part of the milking of each udder quarter in such a way that all udder quarters will be milked-out according to a predetermined chronological order.

Methods are also known in which, prior to the milking, the milking intensity for the individual udder quarters is adjusted in such a way that the udder quarters will be milked-out as much as possible simultaneously. However, in such methods, during milking the milking intensity of the individual udder quarters is controlled with the aid of the milk flow obtained during milking in such a way that the relevant teat cup is prevented from climbing up on the teat. The disadvantage of such known methods is that, due to the latter measure, the udder quarters will not be milked-out at least substantially simultaneously in all cases. Such a method is known from U.S. Pat. No. 4,292,926, the contents of which are hereby incorporated by reference in their entirety.

### SUMMARY OF INVENTION

The invention aims inter alia at providing a method of automatically milking an animal, which method makes it possible for the udder quarters to be milked-out at least substantially simultaneously.

For this purpose, according to the invention, a method of automatically milking an animal having at least two udder quarters is disclosed, in which method the milking of the at least two udder quarters is performed at least partially simultaneously, the method comprising the step of determining, during milking, for each udder quarter a value of a milking parameter of the milk obtained from the relevant udder quarter and controlling the milking intensity during at least a part of the milking of each udder quarter with the aid of the determined value of the milking parameter in such a way that all udder quarters will be milked-out according to a predetermined chronological order. Due to the fact that the milking intensity during milking is controlled in such a way that all udder quarters will be milked-out according to a predetermined chronological order, the milking can take place in an even more animal-friendly way.

In some methods of automatically milking an animal it is customary that after the milking another treatment takes place. The performance of such a post-treatment cannot always take place immediately after the milking, because for the milking of the other udder quarters equipment is required that makes the post-treatment difficult, if not impossible. A teat of a milked-out udder quarter can be post-treated only when all other udder quarters have been milked-out, which may lead sometimes to a long waiting time for the post-treatment. This may lead to harmful effects for the relevant udder quarter, for example in relation to its health and the health of the animal. By controlling the relevant components, according to The invention, in such a way that the udder quarters will be milked-out according to a predetermined chronological order, the milking can be optimally tuned to the further treatments on the teats, so that the animal is milked in a friendly manner (by which is also meant a medically safe manner). It is pointed out here that a short waiting time before a teat of a milked-out udder quarter is post-treated is not harmful in many cases.

A method according to the invention comprises in particular the step of controlling the milking intensity during at least a part of the milking of each udder quarter in such a way that all udder quarters will be milked-out at least substantially simultaneously. It has in fact been found that in the known method, even after a certain quarter has been milked-out (and the teat cup has-already been disconnected), said quarter is stimulated again by milking the other quarters, in particular when the other quarters are milked considerably longer, and the quarter that has already been milked-out again produces milk. Due to this, milk still remains in said quarter, which might lead to health problems for that quarter. Due to the fact that, according to this embodiment of the invention, all quarters will be milked-out at least substantially simultaneously, the renewed stimulation of a milked-out quarter will occur at least to a lesser extent.

According to a preferred embodiment of the method according to the invention said method comprises the step of automatically connecting a teat cup to a teat by means of a robot arm.

Although it is possible to connect the teat cups simultaneously to the teats, for reasons of connection accuracy the teat cups are preferably connected successively to the teats. The points of time of connection are taken into account, preferably together with the expected quarter milking durations, when controlling the milking intensity in such a way that the udder quarters will be milked-out according to a previously adjusted chronological order.

The milking intensity can be controlled in a simple manner in that for the milking intensity at least one milking process parameter is chosen from the group consisting of: milking vacuum, rising rate of the pulsation vacuum, rate of descent of the pulsation vacuum and release-squeeze ratio.

Because the milking vacuum may vary to some extent during milking, and the milking velocity may vary as a result thereof, in an embodiment of a method according to the invention, the method comprises the step of measuring, during the milking of an udder quarter, the milking vacuum under the teat in the teat cup, and the step of controlling the pulsation vacuum in such a way that the maximum underpressure value of the pulsation vacuum is equal to or is a fixed value lower than the measured milking vacuum.

The invention also relates to a device for automatically milking an animal having at least two udder quarters, the device comprising at least two teat cups to be connected to the teat of respective udder quarters, a milking unit for performing the milking of the udder quarters with a milking intensity that is determined by at least one milking process parameter with a determined value, a control device for controlling the milking intensity per udder quarter, the milking unit being controllable by means of the control device in such a way that the milking of the udder quarters takes place at least partially simultaneously, the milking intensities per udder quarter being controllable by means of the control device during at least a part of the milking of each udder quarter in such a way that all udder quarters will be milked-out according to a predetermined chronological order. The device may have at least one milking parameter meter for determining, during milking, per udder quarter a value of a milking parameter of the milk obtained from the relevant udder quarter, the milking parameter meter being connectable to the control device for supplying to the control-device data in relation to the value of the milking parameter, wherein the control device is, used for controlling the milking intensity, with the aid of the determined value of the milking parameter, during at least a part of the milking of each udder quarter in such a way that all udder quarters will be milked-out according to a predetermined chronological order.

In a preferred embodiment of the device according to the invention the control device controls the milking intensities per udder quarter during at least a part of the milking of each udder quarter with the aid of the determined value of the milking parameter in such a way that all udder quarters will be milked-out at least substantially simultaneously.

In a particularly advantageous embodiment of the invention the device may further comprise a milking robot with a robot arm for automatically connecting a teat cup to a teat. Such a milking robot may be suitable for connecting the individual teat cups.

The device may also be provided with a milking vacuum meter for measuring, during the milking of an udder quarter, the milking vacuum under the teat in the teat cup, and a control device for controlling the pulsation vacuum in such a way that the maximum underpressure value of the pulsation vacuum is equal to or is a fixed value lower than the measured milking vacuum.

### BRIEF DESCRIPTION OF DRAWINGS

An embodiment of the invention will now be explained in further detail by way of example only with reference to the accompanying figures, in which:

FIG. 1 shows a teat cup in which a milking vacuum gauge is disposed;

FIG. 2 shows schematically a device for automatically milking an animal;

FIG. 3 shows schematically a common buffer vessel of the device shown in FIG. 2;

FIG. 4 shows schematically an individual buffer vessel of the device shown in FIG. 2, and

FIG. 5 shows schematically a diagram of the pulsation and milking vacuum curve.

### DETAILED DESCRIPTION

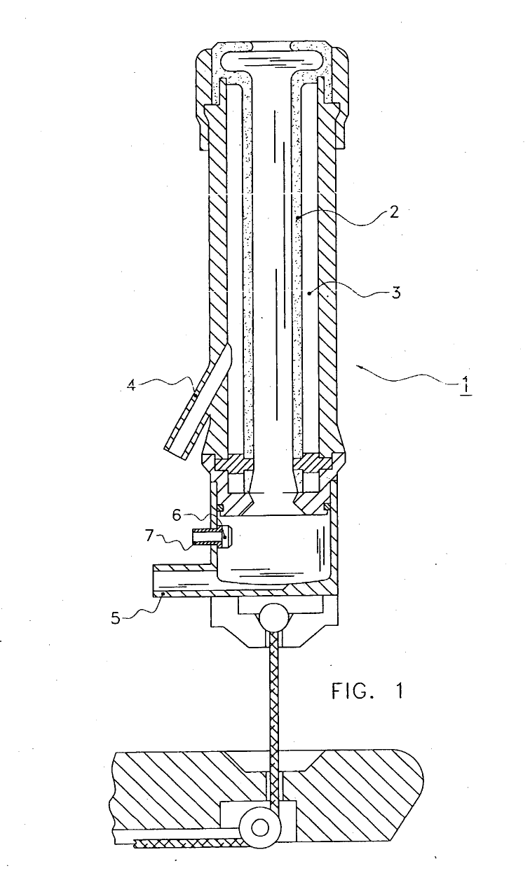

FIG. 1 shows a teat cup 1 with a teat liner 2 and a pulse chamber 3. To the pulse chamber 3 there is connected, via a pulsation line 4, a (non-shown), preferably computer-controlled, adjustable pulsator. Near the lower side of the teat cup 1 there is further disposed a milk line 5. In the lower part of the teat cup 1 there is disposed a milking vacuum gauge 6. The milking vacuum gauge 6 is connected, via a line 7, to a computer or a calculating unit. With the aid of the computer and/or the calculating unit, the computer-controlled adjustable pulsator can be controlled on the basis of the signal emitted by the milking vacuum gauge 6, which signal indicates the value of the milking vacuum. These elements may form part of an automatic milking device of the type known from U.S. Pat. No. 6,713,051, the contents of which are hereby incorporated by reference in their entirety.

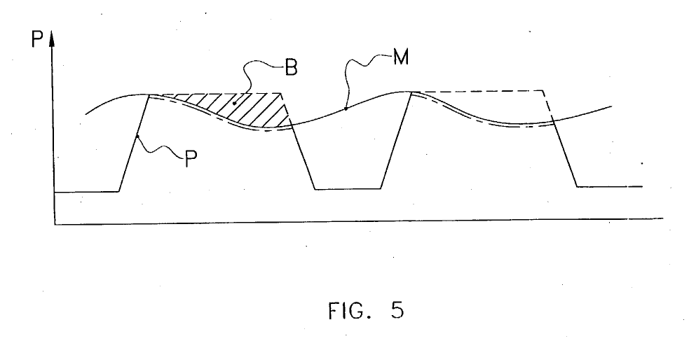

The control of the pulsator will now be explained in further detail with reference to the diagrams in FIG. 5. Here the X-axis is the time axis, whereas the Y-axis indicates the underpressure of the milking vacuum and the pulsation vacuum.

FIG. 5 shows the pulsation curve P indicating the pulsation vacuum generated by the pulsator for one teat. Here the part of the pulsation curve P that is represented by a broken line indicates the pulsation vacuum that is used in a previously known device for automatically milking. FIG. 5 furthermore shows the milking vacuum curve M as measured by the milking vacuum gauge 6. As shown, the milking vacuum varies during milking. The pulsation vacuum also varies and may assume a maximum underpressure value.

In a previously known device for automatically milking an animal the teat of an animal is unnecessarily loaded in the shaded area B situated between the part of the pulsation curve P represented by the broken lines and the relevant part of the milking vacuum curve. This loading may lead to irritation and even inflammation of the teat.

Such a loading of the teat is prevented in that the computer and/or the calculating unit (in general a control device) uses the value of the milking vacuum measured by the milking vacuum gauge 6 for the control of the pulsator for adjusting the pulsation vacuum. Here the relevant components are controlled in such a way that the maximum underpressure value of the pulsation vacuum is equal to or is a fixed value lower than the measured milking vacuum. This is shown in FIG. 5 by the dashed-dotted line belonging to the pulsation curve P.

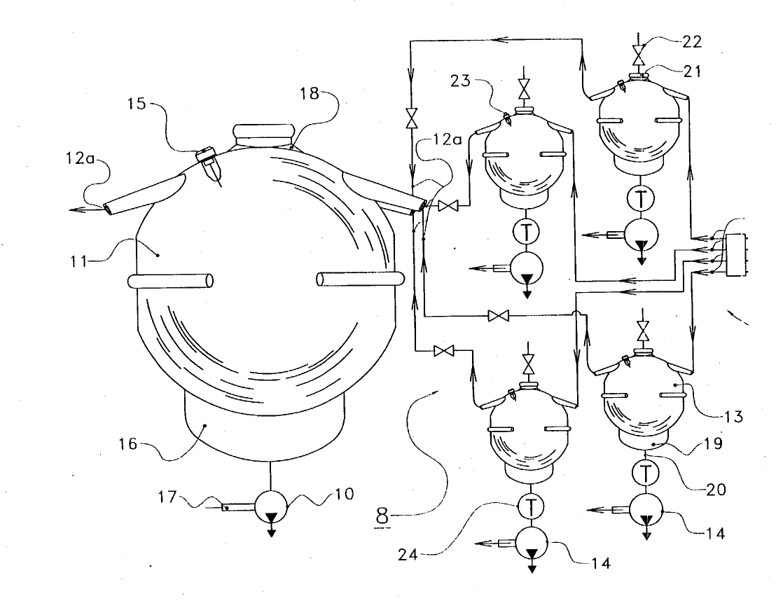

FIG. 2 shows schematically a device 8 for automatically milking an animal. In said device the pulsator is not shown, because the pulsator and the control thereof are known per se, such as for example from DE-A1-3609275, the contents of which are hereby incorporated by reference in their entirety.

The device 8 is provided with at least two teat cups (in the embodiment shown four) to be connected to respective teats of the animal. A milking vacuum unit 9 generates the milking vacuum in the teat cups 1.

The milking vacuum unit 9 is provided with a common vacuum pump 10 and with a common buffer vessel 11 to which vacuum can be applied by means of the common vacuum pump. In the embodiment shown the common vacuum pump 10 for applying vacuum to the common buffer vessel 11 is a frequency-controlled vacuum pump. The common buffer vessel 11 comprises a vacuum sensor 15 for measuring the vacuum in the common buffer vessel 11. The vacuum in the common buffer vessel 11 can be controlled by means of the common vacuum pump 10 with the aid of data from the vacuum sensor 15. The common buffer vessel 11 has for example a content of approximately 30 dm³.

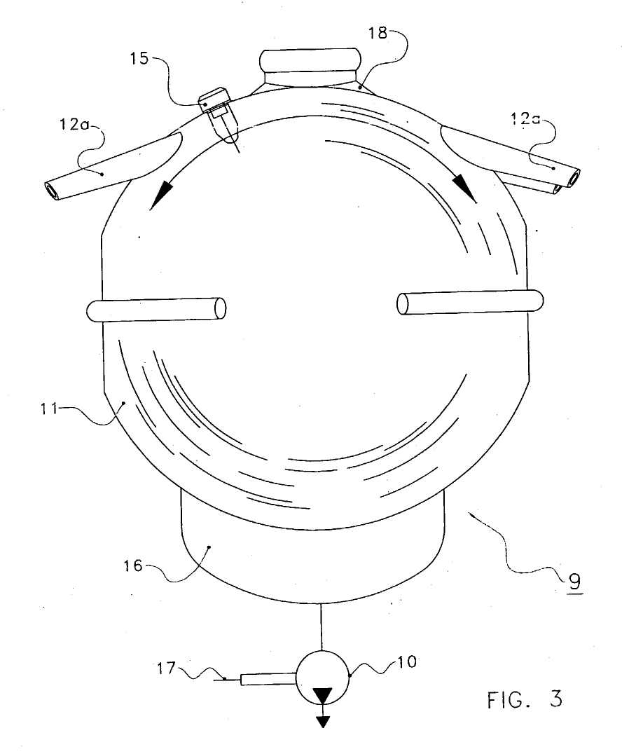

In the embodiment shown, the common buffer vessel 11 has a lower side 16 (FIG. 3). In said lower side 16 there is arranged an outlet 17 in which the common vacuum pump 10 for applying vacuum to the common buffer vessel 11 is disposed. Opposite to the lower side 16 the common buffer vessel 11 has an upper side 18. Each first vacuum line portion 12a can be connected to the upper side 18 of the common buffer vessel 11.

An individual buffer vessel 13 is included in each vacuum line 12 and is positioned between the common buffer vessel 11 and the respective teat cup 1. Each individual buffer vessel 13 can be connected to the common buffer vessel 11 via a first vacuum line portion 12a and to the respective teat cup 1 via a second vacuum line portion 12b. For each individual buffer vessel 13 the device 8 comprises a respective individual milk pump 14 (with milk meter, if desired) for applying vacuum to the individual buffer vessel 13.

Due to the fact that the milking vacuum unit 9 comprises both a common vacuum pump 10 and an individual milk pump 14 per individual buffer vessel 13, it is possible to apply a milking vacuum per teat cup 1 in an accurate and reproducible way.

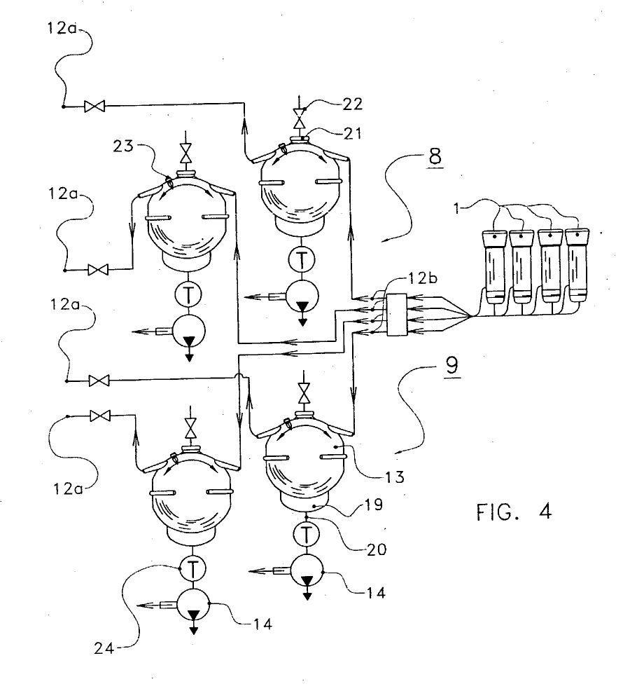

Each individual buffer vessel 13 has a lower side 19 (FIG. 4). In said lower side 19 there is arranged an outlet 20 in which the individual milk pump 14 for applying vacuum to the individual buffer vessel 13 is disposed. The individual buffer vessel 13 also has an upper side 21 to which the respective first vacuum line portion 12a can be connected. Furthermore the second vacuum line portion 12b can also be connected to the upper side 21 of the respective individual buffer vessel 13. In the upper side of the individual buffer vessel 13 there is also disposed an air inlet control valve 22. An individual buffer vessel 13 has for example a content of 1.5 dm³, and also serves as a milk separator.

Analogous to the common buffer vessel, each individual buffer vessel 13 is provided with a vacuum sensor 23 for measuring the vacuum in the individual buffer vessel 13. Here the individual milk pump 14 and/or the air inlet control valve 22, and thus the vacuum in the individual buffer vessel 13, can be controlled with the aid of data from the vacuum sensor 23.

In the first and second vacuum line portion there are disposed controllable valves exercising a function comparable to that of the valves in conventional vacuum line portions.

For applying an even more accurate milking vacuum, if desired, the dimensions of vacuum line portions 12a, 12b are also of importance. A particularly accurately adjustable milking vacuum is obtained if the first vacuum line portion 12a has a maximum capacity of approximately 3500 cm³/s and/or if the second vacuum line portion 12b has a maximum capacity of approximately 12000 cm³/s.

If the device comprises a milking robot known per se with a robot arm for connecting a teat cup to a teat, it is advantageous if at least one individual buffer vessel 13 is disposed on or in the robot arm.

By means of the device described it is possible to generate a very accurate milking vacuum in the teat cup under the teat. It is further possible to control, during milking, said milking vacuum as well as the pulsation vacuum and other milking process parameters, if any, by means of the control device provided with software (for example a computer and/or a calculating unit) in such a way that all udder quarters will be milked-out at least substantially according to a predetermined chronological order, in particular simultaneously. Said milking process parameters determine the milking intensity.

Such a chronological order may be for example that the udder quarters will be milked-out approximately 1 minute (other periods of time are also possible of course) after each other. In this way a robot arm can remove the teat cups one by one from the teats, or the teats can be post-treated one by one. If the udder quarters have been milked-out at least substantially simultaneously, the teat cups can be removed from the teats simultaneously, so that the milking has a defined end time, which offers advantages.

The milking intensity can be controlled by varying in particular at least one milking process parameter chosen from the group consisting of: milking vacuum, rising rate of the pulsation vacuum, rate of descent of the pulsation vacuum and release-squeeze ratio. Varying such process parameters, although for other purposes, is known per se and needs not to be set out here in further detail.

The device 8 is further provided with at least one milking parameter meter 24, in the embodiment shown a thermometer, for determining, during milking for each udder quarter a value of a milking parameter (for example the temperature) of the milk obtained. It is pointed out here that the location of the milking parameter meter 24 in the figure is purely schematically, and it will be obvious that it may also be disposed in other suitable places. The control device is in particular suitable for controlling the milking of each udder quarter by means of the milking vacuum unit or the pulsator unit at least partially with the aid of the determined value of the milking parameter (for example the temperature). When for example the temperature of the milk obtained demonstrates an unexpected increase, which could be an indication of for example a too high milking vacuum in the teat cup under the teat, the control device is capable of adjusting the milking intensity for the relevant teat in such a way that the temperature comes again within nominal values. Due to the fact that the milking intensity for the relevant udder quarter is adjusted during milking, the control unit also controls the milking intensities of the other udder quarters, so that the udder quarters will again be milked-out according to the predetermined chronological order. Said control preferably takes place fully automatically, of course.

Besides the temperature, other milking parameters, such as fat content, protein content, milk flow, conductivity, colour and the like may be applied, of course.

The milking parameter meter is in particular a quarter milking duration meter known per se for determining the quarter milking duration per udder quarter. The device 8 is then provided with a calculating device for determining an expected quarter milking duration from historical quarter milking durations. The calculating device is in particular suitable for determining the average of the quarter milking duration of a previously adjustable number of milking runs (for example eight or ten, but any other number may be applied as well) of said udder quarter. It is thus possible to adjust, prior to the milking, the milking intensities per udder quarter on the basis of the expected quarter milking durations. It is in particular possible to control the functioning of the milking vacuum unit or the pulsator unit.

If the measurement of a momentary milking parameter gives cause for it, it is thus also possible to adjust the milking intensity during milking.

Many modifications in addition to those described above may be made to the structures and techniques described herein without departing from the spirit and scope of the invention. Accordingly, although specific embodiments have been described, these are examples only and are not limiting upon the scope of the invention.

1. A method of automatically milking an animal having at least two udder quarters, wherein the milking of the at least two udder quarters is performed at least partially simultaneously, the method comprising:
determining, during milking, for each of the udder quarters a value of a milking parameter of the milk obtained from the relevant udder quarter; and
controlling the milking intensity during at least a part of the milking of each udder quarter being controlled with the aid of the determined value of the milking parameter in such a way that all of the udder quarters will be milked-out according to a predetermined chronological order.

2. The method as claimed in claim 1, wherein the step of controlling the milking intensity comprises controlling the milking intensity during at least a part of the milking of each udder quarter with the aid of the determined value of the milking parameter in such a way that all of the udder quarters will be milked-out at least substantially simultaneously.

3. The method as claimed in claim 1, the method further comprising automatically connecting a teat cup to a teat of one of the udder quarters by means of a robot arm.

4. The method as claimed in claim 3, wherein the teat cups are connected successively to the teats.

5. The method as claimed in claim 1, wherein for controlling the milking intensity at least one milking process parameter is controlled, chosen from the group consisting of: milking vacuum, pulsation vacuum, and release-squeeze ratio.

6. The method as claimed in claim 5, the method further comprising:
measuring, during the milking of an udder quarter, the milking vacuum under the teat in the teat cup; and
controlling the pulsation vacuum in such a way that the maximum underpressure value of the pulsation vacuum is equal to or is a fixed value lower than the measured milking vacuum.

7. A device for automatically milking an animal having at least two udder quarters, the device comprising:
at least two teat cups to be connected to teats of respective ones of the udder quarters;
a milking unit for performing the milking of the udder quarters with a milking intensity that is determined by at least one milking process parameter with a determined value;
a control device for controlling the milking intensity per udder quarter, the milking unit being controllable by means of the control device in-such a-way that the milking-of the udder quarters takes place at least partially simultaneously; and
at least one milking parameter meter for determining, during milking, per udder quarter a value of a milking parameter of the milk obtained from the relevant udder quarter, the milking parameter meter being connectable to the control device for supplying to the control device data in relation to the value of the milking parameter;
wherein the control device controls the milking intensity with the aid of the determined value of the milking parameter, during at least a part of the milking of each of the udder quarters in such a way that all of the udder quarters will be milked-out according to a predetermined chronological order.

8. The device as claimed in claim 7, wherein the control device controls the milking intensities per udder quarter during at least a part of the milking of each udder quarter with the aid of the determined value of the milking parameter in such a way that all udder quarters will be milked-out at least substantially simultaneously.

9. The device as claimed in claim 7, wherein the device further comprises a milking robot with a robot arm for automatically connecting a teat cup to a teat.

10. The device as claimed in claim 9, wherein the milking robot is capable of separately connecting the individual teat cups.

11. The device as claimed in claim 7, wherein the device comprises a milking vacuum meter for measuring, during the milking of an udder quarter, the milking vacuum under the teat in the teat cup, and a control device for controlling a pulsation vacuum in such a way that a maximum underpressure value of the pulsation vacuum is equal to or is a fixed value lower than the measured milking vacuum.

12. A device for automatically milking an animal having at least two udder quarters, the device comprising:
at least two teat cups to be connected to teats of respective ones of the udder quarters;
a milking unit for at least partially simultaneously performing the milking of the respective udder quarters; at least one milking parameter meter for determining, during milking, per udder quarter a value of a milking parameter of milk obtained from the respective udder quarter; and
a control device which receives data relating to the value of the respective milking parameters and controls the milking unit to individually provide a given milking intensity per udder quarter during at least a part of the milking of each udder quarter in such a way that all of the udder quarters will be milked-out according to a predetermined chronological order.

13. A device as claimed in claim 12, wherein the control device controls the milking intensities per udder quarter during at least a part of the milking of each of the udder quarters with the aid of the determined value of the milking parameter in such a way that all of the udder quarters will be milked-out at least substantially simultaneously.

14. A device as claimed in claim 13, wherein the device further comprises a milking robot with a robot arm for automatically connecting a teat cup to a teat.

15. A device as claimed in claim 14, wherein the milking robot is capable of separately connecting the individual teat cups.

16. A device as claimed in claim 14, wherein the device comprises a milking vacuum meter for measuring, during the milking of an udder quarter, the milking vacuum under the teat in the teat cup, and a control device for controlling a pulsation vacuum in such a way that a maximum underpressure value of the pulsation vacuum is equal to or is a fixed value lower than the measured milking vacuum.
